(19) United States
(12) Patent Application Publication
(10) Pub. No.: US 2020/0157015 A1
(43) Pub. Date: May 21, 2020

(54) FERTILIZER FORMULATION CONTAINING Si CLAY

(71) Applicant: Helena Agri-Enterprises, LLC, Collierville, TN (US)

(72) Inventor: CHRIS ALBRIGHT, Jensen Beach, FL (US)

(21) Appl. No.: 16/681,010

(22) Filed: Nov. 12, 2019

Related U.S. Application Data
(60) Provisional application No. 62/776,560, filed on Dec. 7, 2018.
(60) Provisional application No. 62/767,743, filed on Nov. 15, 2018.

(51) Int. Cl. C05D 9/00; C05G 3/00

(52) U.S. Cl. CPC C05D 9/00; C05G 3/0058

(57) ABSTRACT

A fertilizer composition containing a fertilizer and Si clay granules wherein the Si clay is an amount from about 10 to about 90% by weight based on the total amount of the composition. A process of fertilizing a crop which has the step of applying the fertilizer composition to the ground.

### CROSS-REFERENCE TO RELATED APPLICATIONS

This application claims benefit to U.S. Provisional applications 62/767,743 filed Nov. 15, 2018 and 62/776,560 filed Dec. 7, 2018 which are both incorporated by reference in their entirety for all useful purposes.

### BACKGROUND OF THE INVENTION

Silicon “Si” is considered a “functional” or “beneficial” (rather than essential) plant nutrient. In Florida, Si amendments may increase cane and sugar yields as much as 25% and may support more successful ratoon crops.

Adding a soil amendment, also called a soil conditioner, helps improve plant growth and health. The type of amendment or amendments added depends on the current soil composition, the climate, and the type of plant. Some of the various amendments include:

1. Lime (makes soil less acidic)
2. Fertilizers for plant nutrients (i.e. manure, peat, or compost)
3. Materials for water retention (i.e. clay, shredded bark, or vermiculite)
4. Gypsum (releases nutrients anti improves structure)
5. Clay (allows water to reach the plant root).

Various elements, which are normally drawn from the soil, are known to be essential to plant nutrition. These elements include: nitrogen (N), phosphorus (P), potassium (K), sulfur (S), calcium (Ca), magnesium (Mg), iron (Fe), manganese (Mn), copper (Cu), cobalt (Co), zinc (Zn), boron (B), nickel (Ni), molybdenum (Mo), and chlorine (Cl). Of these elements, nitrogen, phosphorus, potassium, sulfur, calcium, and magnesium are needed by plants in relatively large quantities and are therefore called macronutrients. The remaining members of the group (iron, manganese, copper, cobalt, zinc, boron, nickel, molybdenum, and chlorine) are known as micronutrients since they are required in very small amounts for plant growth.

Supplying a plant's major nutrient needs (nitrogen, phosphorus, potassium-N—P—K) is most effective and economical via soil application. However, foliar application has proven to be an excellent method of supplying plant requirements for secondary macronutrients (sulfur, calcium, magnesium) and micronutrients (carbon (C), hydrogen (H), and oxygen (O), nitrogen (N), phosphorus (P) and potassium (K), while supplementing N—P—K needs for short and/or critical growth stage periods. Additionally, the so called micronutrients, also commonly provided by mineral fertilizers are: boron (B), chlorine (Cl), copper (Cu), iron (Fe), manganese (Mn), zinc (Zn) and molybdenum (Mo). Foliar application refers to the application of plant nutrients to above-ground plant parts. Foliar fertilization programs prolong the fertilizing application period, providing a continuous supply of nutrients when crop demand is at a maximum, and can be an economical way to boost yield.

In fertilization programs, sulfate metal salts (e.g., zinc sulfate, manganese sulfate, and copper sulfate) are an economical source affording both sulfur and micronutrients.

Humectants have also been used to help retain water within the soil and plant tissue. These features make the incorporation of a humectant into a foliar fertilizer potentially beneficial to the needs of the plant.

Si applications with sugarcane have been discussed in detail in the publication, Savant, N. K, Korndorfer, G. H., Datnoff, L. E. and Snyder, G. H. 1999. Silicon Nutrition And Sugarcane Production: A Review, J. Plant Nutr. 22 (12):1853-1903 (Savant) which is incorporated by reference. Savant disclose the using silicate slag and calcium silicate slag as the source of Si for sugarcane.

Calcium silicate slag, a popular Si source, tends to have low solubility under high soil pH conditions. Growers have experimented with Ca-silicate slag applications for many years. This collective experience suggests that when soils test low for acetic acid extractable Si (less than 10 ppm in the soil extract), a 3 ton/Acre application of Ca-silicate slag will likely support favorable yield improvements over a three-crop cycle. A three-crop cycle is where the same crop is grown for three years. The Si source is generally broadcast applied and disked into the soil prior to planting.

Leaf Si analysis is very useful in combination with soil test Si values in determining the need for calcium silicate application.

Deficiency symptoms: Si deficiency is characterized by minute, circular white leaf spots (freckles). The freckling is more severe on older leaves. Older leaves may senesce prematurely, and the stools exhibit poor tillering and ratooning characteristics.

The philosophy that drives this is one identified by the American Society of Agronomists and is called the 4R's.

Right product

Right rate

Right timing

Right place

Current practices of adding silicon has been reduced to a soil amendment process and only applied prior to planting, (sugarcane is planted once in 3 years and yields three crops, one per year). This application requires 1-3 tons per acre every 3-4 years and in 2018 costs up to $200 per acre. Not only is this an expensive input, but one that runs contrary to the concept of the 4R's.

Agsorb® is a clay-based granules from OIL-DRI Corporation of America, has been used in the fertilizer industry as a fertilizer blend conditioning agent. Fertilizer salts by virtue of their properties absorb moisture and this phenomenon is exasperated when certain fertilizer materials are blended together and so the need for a conditioning agent. Agsorb® can mitigate the impact of excessive moisture in a blend, preserving manageable application properties of the blend for the grower. Agsorb® is granules that include Montmorillonite from Ripley Miss. or from Mounds Ill., Attapulgite from Ochlocknee Ga., Hysrous Aluminosilicate from Taft, Calif. Below is the technical sheets for the above material from OIL-DRI:

Granules

| | | | | | Liquid | Bulk |
|---|---|---|---|---|---|---|
| | | | Size Guide | Uniformity | Holding | Density |
| Production | | | Number Ps | Index Ps | Capacity | Lbs/Ft³ |
| Location & Mineral | Product | Process | 006.01.01 | 006.01.01 | Wt % E1521-93 | E1521-91 |
| Classification | Name | Options | (GSA) | (GSA) | (ASTM) | (ASTM) |
| Ripley, MS | 30/60 | RVM | 40 | 50 | 31 | 37 |
| MONTMORILLONITE | 24/48 | LVM | 55 | 45 | 33 | 36 |
| | 16/30 | LVM | 85 | 50 | 33 | 36 |
| | 8/16 | LVM | 170 | 55 | 33 | 35 |
| | 5/20 | LVM | 215 | 25 | 33 | 35 |
| | 40/100 | LVM | ALPINE SIEVE PS | | 33 | 37.5 |
| | | | 006.01.01 (GSA) | | | |
| | | | 90% −325/+120 MESH | | | |
| Ochlocknee, GA | 24/48 | LVM | 55 | 40 | 35 | 32 |
| ATTAPULGITE | 16/30 | RVM | 85 | 50 | 32 | 33 |
| | 16/30 | LVM | 85 | 50 | 35 | 32 |
| | 12/24 | LVM | 110 | 60 | 35 | 31 |
| | 8/16 | LVM | 170 | 55 | 35 | 31 |
| | 5/20 | LVM | 215 | 25 | 35 | 32 |
| Taft, CA | 24/48 | RVM | 55 | 40 | 27 | 39 |
| HYDROUS | 16/30 | RVM | 85 | 50 | 27 | 38 |
| ALUMINOSILICATE | 5/20 | RVM | 215 | 25 | 27 | 40 |

| | | Moisture | Particle | Attrition | |
|---|---|---|---|---|---|
| Production | pH | Content Wt % | Count | % Resistance | |
| Location & Mineral | In 001.01.01 | D2216-80 | E1520-93 | P-A 1056 B | Available |
| Classification | (ODC) | (ODC) | (ASTM) | (GSA) | Colors |
| Ripley, MS | 5 | 7 | 10.1 | 75-85 | GRAY |
| MONTMORILLONITE | 5 | <3 | 8.6 | 85-90 | GRAY OR RED |
| | 5 | <3 | 1.6 | 85-90 | GRAY |
| | 5 | <3 | 0.4 | 85-90 | GRAY OR RED |
| | 5 | <3 | 0.5 | 85-90 | GRAY OR RED |
| | 5 | 1.5 | 18 | 85-90 | GRAY OR RED |
| Ochlocknee, GA | 6 | <3 | 9.0 | 80-90 | LIGHT GRAY |
| ATTAPULGITE | 7 | 12 | 1.8 | 75-85 | TAN |
| | 6 | <3 | 1.6 | 80-90 | LIGHT GRAY |
| | 6 | <3 | 0.9 | 80-90 | LIGHT GRAY |
| | 6 | <3 | 0.4 | 80-90 | LIGHT GRAY |
| | 6 | <3 | 0.6 | 80-90 | LIGHT GRAY |
| Taft, CA | 8 | <6 | 5.0 | 75-85 | TAN |
| HYDROUS | 8 | <5 | 1.2 | 75-85 | TAN |
| ALUMINOSILICATE | 8 | <5 | 0.4 | 75-85 | TAN |

Powders

| | | | | Packed Bulk | | Moisture |
|---|---|---|---|---|---|---|
| Production | | | Alpine Sieve | Density Lbs/Ft³ | pH | Content Wt % |
| Location & Mineral | Product | Process | Ps 006.01.01 | 23-Nf-18-Usp1 | In 001.01.01 | D2216-80 |
| Classification | Name | Options | (GSA) | (USP) | (ODC) | (ODC) |
| Ochlocknee, GA | −325 | RVM | 80% −325 mesh | 43 | 7 | 15 |
| ATTAPULGITE | −325 | LVM | 80% −325 mesh | 38 | 7 | 5 |
| | −325 | ULT | 80% −325 mesh | 37 | 6 | 3 |
| Mounds, IL | −325 | RVM | 80% −325 mesh | 43 | 5 | 10 |
| MONTMORILLONITE | −325 | LVM | 80% −325 mesh | 40 | 5 | 3 |

In 2018, on the SDS sheets for Agsorb® had a 70% SiO₂ guarantee and thought that since it was already sized and designed to be added to blend granular fertilizer, what if we could render the crop required Si from this source?

Verge™ from Oil-Dri has a durable outer core that prevents tiny fragments from breaking off, unlike traditional, irregular-shaped granules that rub together during handling, transportation, and formulation. Verge™ technical specifications are as follows:

| | LPHD | S Slow | N Non- |
|---|---|---|---|
| | disintegrating | disintegrating | disintegrating |
| density | 48.5 | 48 | 46 |
| dust index | <0.3 | <0.3 | <0.3 |
| hardness | 94 | 93 | 96 |
| liquid hold capacity | 22 | 23 | 25 |
| moisture | 5 | 6 | 2 |
| pH | 6 | 5 | 5 |
| | SGN 100 | SGN 140 | SGN200 |
| mesh size | 16/30 | 12-20 | 8/16 |
| uniformity index | −60 | −60 | −60 |
| angle of repose | 27° | 25° | 25° |
| Granlues per lb. | −900 k/lb | −400 k/lb | −200 k/lb |

US Patent No. 2017/0360029, which is incorporated by reference, discloses a chemical agent for controlling soil nematode. In formulation example 5 uses attapuligite as a carrier.

US Patent Publication No. 2013/0210624 ('624 publication) which is incorporated by reference, discloses granular material employed as a fungicide or a fertilizer or both, comprising phosphorous acid (H₃PO₃) or phosphite (which may include HPO₃), along with a metal and phosphate on a granular carrier; or a mixture of a phosphite product and a phosphate product on a granular carrier; or mixture of a metal phosphite product and phosphate on a granular carrier. The mixture may contain a chelated metal on a granular carrier. Another mixture includes a phosphite product on a first granular carrier, and a phosphate product on a second granular carrier wherein the two are mixed and the phosphite product and the phosphate product may or may not include a metal ion. Alternatively, the mixture may also contain a chelated metal on a third granular carrier.

The '624 publication discloses in paragraph no. [0054] clay-based granules such as that sold by Oil-Dri Corporation as Verge™ may be formulated to disintegrate at an extremely fast rate such as one minute, or to dissolve far more slowly into thousands of microparticles.

### SUMMARY OF THE INVENTION

It is an object of the invention to find Si source(s), preferably in granular form that could be added to a fertilizer, in particular to a granular fertilizer. The Si source then could be applied at the same time as other fertilizers. This would complement the concept of the 4R's, thereby maximizing input efficiencies, get better yields and quality and probably save the grower money.

An object of the invention was to be able to reduce the amount of fertilizer blends used on the fields and to save the growers time from applying the product. Therefore, there would be less product placed on the fields and this would give the grower more time.

The advantages would be as follows:
The product can travel with all fertilizer blends thereby eliminating the soil amendment of 1-3 tons.
   This opens the door to evaluate for optimum timing and rates of Si for example with sugarcane which is fertilized 2-5 times annually.
   This opens the door to evaluate for optimum placement of Si in conjunction with the growth stage of the crop.
Instead of 1-3 tons, equivalent Si input would only require 250-750 (respectively) pounds with half the cost.
In conjunction with supplying Si to the crop, when applied at 750 lbs per acre into the planting drill, the absorbent properties of the product would serve to hold moisture around the seed-piece.

The invention relates to a fertilizer composition comprising a fertilizer and Si clay granules wherein the Si clay granules are in an amount from about 10 to about 90% by weight based on the total amount of the fertilizer and Si clay.

The fertilizer can contain acids such as organic or inorganic acids.

Inorganic acids, include mineral acids selected from the group consisting of nitric acid, phosphoric acid, sulfuric acid, and mixtures thereof; and phosphorous acid ammonia can be used.

Organic acids are preferably fulvic acid, humic acid, citric acid and carboxylic acid, preferably C₁ to C₂₀ carboxylic acid.

Rendering of the “Si” into a plant available form, (SiO2), is made possible by increasing acidity. To point, the acidity of the blend, even partner components inside the blend, that serve to reduce the pH of the soil within the placement zone of the fertilizer containing AgSorb, triggers the process of changing SiO₄ (reserve Si and not plant available) to SiO₂.

The fertilizer can contain micronutrients and macronutrients as discussed above in the background of the invention section of the application.

The invention also relates to a process of fertilizing a crop which comprises applying the fertilizer to the ground (soil).

### A DETAILED DESCRIPTION OF THE INVENTION

The invention relates to a fertilizer composition comprising a fertilizer and Si clay granules wherein the Si clay is an amount from about 10 to about 90% by weight based on the total amount of the fertilizer and Si clay.

The fertilizer composition can be used for plants such as, but not limited to grass crops, turf crops, cucurbit crops, brassica crops or solanaceae crops.

Grass crops include but are not limited to barley, maize (corn), oats, rice, rye, sorghum, wheat, millet, sugar cane or bamboo.

Turf crops include but are not limited to Bermuda grass, St. Augustine grass, Zoysia grass, Kentucky bluegrass or Perennial ryegrass.

Cucurbit crops include but are not limited to pumpkin, squash, zucchini, cucumber, watermelon or gourd.

Brassica Crops include but are not limited to cabbage, cauliflower, broccoli, mustard, brussel sprouts, turnips/turnip greens, collards, kale or bok choy.

Solanaceae crops include but are not limited to tomatoes, tomatillos, eggplant, potatoes, goji berries, tobacco, peppers (bell peppers, chili peppers, paprika, tamales, tomatillos, pimentos, cayenne, etc).

The fertilizer can be any fertilizer such as a fertilizer containing Nitrogen, Phosphorous and potassium (K) referred to as “NPK” or a fertilizer which does not contain any nitrogen referred to as a XPK. The fertilizer contain boron, zinc, copper, iron, blends of nitrogen phosphorous and potash or mixtures thereof.

The fertilizer can be ammonia sulfate, an ammonia salt of a carboxylic acid, mono- or di-potassium phosphate, a micronutrient, ammonia nitrate, urea, ammonia citrate or ammonia acetate.

The Si clay can be any Si clay. The Si clay is preferably, Agsorb® which is granules that include Montmorillonite from Ripley Miss. or from Mounds Ill., Attapulgite from Ochlocknee Ga., Hydrous Aluminosilicate from Taft, Calif. and Verge™ also from Oil-Dri.

Prior to the invention it was known to use a conditioner such as Si clay up to 100 pounds per ton fertilizer. I have found that it is much better to increase the amount of Si clay and it should be in an amount from about 200 to about 1800 pounds to the ton fertilizer. Another words the amount of the Si clay is from about 10% by weight to about 90% by weight, and preferably from 20 to 60% by weight and most preferably 40 to 60% weight of the total weight of fertilizer and Si.

Optional components can be pH reducer and micronutrients.

A pH reducer can be used to lower the pH of the fertilizer composition would be greater than 10, preferably about 12. The pH reducer can be any acid such as an organic acid, such as but not limited to citric acid or carboxylic acid or Essence 6 from Helena Agri-Enterprises LLC (Helena). Essence 6 is a concentrated organic acid complex. Its low pH, clear amber liquid formulation will also clear drip irrigation lines. Essence 6 contains Helena's NutrAsyst Formulation Technology (NFT), a high quality blend of organic acids that is designed to improve the performance of liquid fertilizers. About 2 quarts per acre.

The composition can contain micronutrients such as, but not limited to a water soluble salt of boron, iron, manganese, magnesium, copper or zinc.

The fertilizer composition according to the invention should be applied to the soil in an amount from about 200 to about 1500 pounds and preferably about 300 to about 1000 pounds and most preferably 400 to 700 pounds per acre.

Sugarcane fertilization requires around 600 pounds of custom fertilizer at planting and 200-300 pounds 3-5 times through the crop cycle (12 months). I was able to incorporate this SiO₂ product with the fertilizer blend in any of these application slots and therefore take advantage of the timing and rate piece of the input strategy.

### Examples

Two examples were made with one example using a first sample according to the invention using Agsorb® and the second example with a calcium silicate slag. I compared the results and evaluated with respect to Si. The results are as follows:

| Example 1 according to the invention | |
|---|---|
| Calcium | 1.49% |
| Magnesium (Total) | 2.22% |
| Magnesium (Water Soluble) | 0.05% |
| Aluminum | 2.61% |
| Total Silicon | 41.20% |
| Extractable Silicon Mehlich 3 (M3) SiO₄ | 1449.42 ppm |

W = Wet (as received) BASIS

| Example 2 using calcium silicate slag | |
|---|---|
| Calcium | 23.40% |
| Magnesium (Total) | 2.16% |
| Magnesium (Water Soluble) | 0.01% |
| Aluminum | 1.74% |
| Total Silicon | 4.12% |
| Extractable Silicon Mehlich 3 (M3) SiO₄ | 832.46 ppm |

W = Wet (as received) BASIS

Two samples of each, were evaluated as a fertilizer source and the Agsorb® rendered 10× available SiO₂ than the slag source. In addition to that, I evaluated each source for soluble Si as well and the Agsorb® had 50% more soluble (immediately available) Si.

I checked two samples of each product using 50 grams of each product was added to 200 ml of distilled water for 30 clay with random, equivalent agitation. Samples were evaluated as a fertilizer. Filtrate is the solid caught in 50 micron filter, water soluble is the liquid that passed through the filter Slag same collected at Townsite.

| | Water solubable | Filtrate: | Raw: |
|---|---|---|---|
| | SiO2 | Total SiO2 | Total SiO2 |
| Agsorb | 1.99% | 37.05% | 47.05% |
| Slag | 1.43% | 5.93% | 4.90% |

All ranges disclosed herein are inclusive of the endpoints, and the endpoints are independently combinable with each other (e.g., ranges of “10% to 90%, is inclusive of the endpoints and all intermediate values of the ranges of “10 to 90” etc.). “Combination” is inclusive of blends, mixtures, alloys, reaction products, and the like. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

All the references described above are incorporated by reference for all useful purposes.

I claim:

1. A fertilizer composition comprising a fertilizer and Si clay granules wherein the Si clay is an amount from about 10% to about 90% by weight based on the amount of the composition.

2. The fertilizer composition as claimed in claim 1, wherein the Si clay is Attapulgite.

3. The fertilizer composition as claimed in claim 1, wherein the Si clay is present in an amount from 20 to 60% by weight.

4. The fertilizer composition as claimed in claim 1, wherein the Si clay is present in an amount from 40 to 60% by weight.

5. The fertilizer composition as claimed in claim 1, which further comprises a pH reducer.

6. The fertilizer composition as claimed in claim 5, wherein the pH reducer is an organic acid.

7. The fertilizer composition as claimed in claim 1, which further comprises an organic or inorganic acid.

8. The fertilizer composition as claimed in claim 1, which further comprises macronutrients or micronutrients.

9. A process of fertilizing a crop which comprises applying the fertilizer composition as claimed in claim 1 to the ground.

10. The process as claimed in claim 9, wherein the fertilizer is applied in an amount from about 200 to about 1500 pounds per acre.

11. The process as claimed in claim 10, wherein the crop is a grass crop, turf crop, cucurbit crop, brassica crop or solanaceae crop.

12. The process as claimed in claim 10, wherein the crop is barley, maize, oats, rice, rye, sorghum, wheat, millet, sugar cane or bamboo.

13. The process as claimed in claim 10, wherein the crop is Bermuda grass, St. Augustine grass, Zoysia grass, Kentucky bluegrass or Perennial ryegrass.

14. The process as claimed in claim 10, wherein the crop is pumpkin, squash, zucchini, cucumber, watermelon or gourd.

15. The process as claimed in claim 10, wherein the crop is cabbage, cauliflower, broccoli, mustard, brussel sprouts, turnips/turnip greens, collards, kale or bok choy.

16. The process as claimed in claim 10, wherein the crop is tomatoes, tomatillos, eggplant, potatoes, goji berries, tobacco or peppers.

17. The process as claimed in claim 10, wherein the crop is sugarcane.

18. The process as claimed in claim 10, wherein the crop is rice.

19. The process as claimed in claim 10, wherein the fertilizer composition is applied in an amount from 300 to 1000 pounds per acre.

20. The process as claimed in claim 10, wherein the fertilizer composition is applied in an amount from 400 to 700 pounds per acre.
